(19) United States
(12) Patent Application Publication
(10) Pub. No.: US 2021/0032764 A1
(43) Pub. Date: Feb. 4, 2021

(54) CONVERTING SUNLIGHT TO LIQUID FUEL

(71) Applicant: KING ABDULLAH UNIVERSITY OF SCIENCE AND TECHNOLOGY, Thuwal (SA)

(72) Inventors: Kim Choon NG, Thuwal (SA); Muhammad BURHAN, Lahore (PK); Muhammad Wakil SHAHZAD, Rahim Yar Khan (PK); Peng WANG, Thuwal (SA)

(21) Appl. No.: 16/981,588

(22) PCT Filed: Mar. 7, 2019
(86) PCT No.: PCT/IB2019/051862

§ 371 Date: Sep. 16, 2020

Related U.S. Application Data
(60) Provisional application No. 62/649,936, filed on Mar. 29, 2018.

(51) Int. Cl. C25B 9/04; H02S 20/32; H02S 40/22; H02S 40/38; G02B 19/00; G02B 3/08; G01J 1/04; G01J 1/42; C25B 3/04; G06T 7/70

(52) U.S. Cl. CPC C25B 9/04; H02S 20/32; H02S 40/22; H02S 40/38; G02B 19/0042; G01J 2001/4266; G02B 3/08; G01J 1/0411; G01J 1/42; C25B 3/04; G06T 7/70; G02B 19/0009

(57) ABSTRACT

A system includes a concentrated photovoltaic (CPV) array that includes a plurality of multi-junction solar cell modules, each of which includes a plurality of multi-junction solar cells and solar concentrating optics mounted on a two-axis solar tracker. The system also includes an energy storage system configured to receive electricity produced by the CPV array and configured to convert the electricity into formic acid by electrolysis.

### CROSS-REFERENCE TO RELATED APPLICATIONS

This application claims priority to U.S. Provisional Patent Application No. 62/649,936, filed on Mar. 29, 2018, entitled “FUEL FROM SUNLIGHT: SUSTAINABLE CONVERSION OF SUNLIGHT AND CO2 TO FORMIC ACID WITH LOW-COST AND HIGHLY EFFICIENT COMPACT CONCENTRATED PHOTOVOLTAIC (CPV),” the disclosure of which is incorporated herein by reference in its entirety.

### BACKGROUND

### Technical Field

Embodiments of the disclosed subject matter generally relate to systems and methods for conversion of sunlight to liquid fuels. More specifically, exemplary embodiments relate to a concentrated photovoltaic (CPV) array that is coupled to an energy storage system that converts electricity produced by the CPV array into formic acid, as well as to systems and methods for adjusting the orientation of a multi-junction solar cell module relative to the current position of the sun.

### Discussion of the Background

Due to the increasing effects of climate change, there is significant research into green energy generation as an alternative to fossil fuels. Solar cells are commonly used as an alternative to fossil fuels. The most commonly-used type of solar cells are single junction silicon-based solar cells, such as those having a mono-crystalline, poly-crystalline, or thin-film structure. Although these types of solar cells have a theoretical limit of 31% efficiency, the actual long-term electricity rating is less than 8% efficiency.

Multi-junction solar cells are a more efficient alternative to single junction solar cells, with current multi-junction solar cells exhibiting an instantaneous cell-efficiency exceeding 46%. These solar cells include a stack of a number of p-n junctions made of different semiconductor materials so that the p-n junction of each material produces electricity in response to different wavelengths of light. The application of current multi-junction solar cells, in form of concentrated photovoltaic (CPV), has limited the acceptance of such solar cells because these CPV systems require massive structures and open land spaces.

In order to optimize the amount of energy produced by solar cells, the orientation of these CPV systems relative to the sun is typically adjusted so that the maximum amount of available sunlight is absorbed by the solar cells. The most common form of solar tracking sensors available in the market for single junction solar cells are based on conventional designs of tilt surface, shadow rod, or collimating tube with photosensor arrays. Although these tracking sensors provide sufficient accuracy for single-junction solar cells, these tracking sensors do not provide sufficient tracking accuracy for use with multi-junction solar cells, in form of CPV.

The only solar feedback sensor currently available in the market for CPV systems employ a position sensitive diode. These types of solar feedback sensors are expensive and are cost-prohibitive when deployed across each CPV in the whole field.

One of the most commonly cited problems for the adoption of solar energy is that electricity is only produced when the sun's rays are available. Solar cells produce no electricity at night and produce a reduced amount of electricity when there is cloud cover. Accordingly, solar energy alone is insufficient for meeting electricity needs.

There are various solutions for addressing the lack of 24/7/365 availability of energy produced by solar cells. One solution is to store the energy in conventional batteries. These batteries have a low storage capacity and short lifespan, and thus are not particularly suitable for cost-efficient, long term storage of electricity generated from solar energy. Another solution is to use the electricity generated by solar cells to perform water splitting, which stores the energy in the form of hydrogen. Hydrogen, however, must be stored at high pressure and is flammable. Accordingly, the hazardous nature of hydrogen storage has discouraged adoption of this form of energy storage.

Thus, it would be desirable to provide systems and methods that allow for space-efficient designs of a CPV array. It would also be desirable to provide systems and methods for tracking the sun that satisfies the accuracy requirements of multi-junction solar cells in a CPV array. Further, it would be desirable to provide for systems and methods for storing electricity produced by multi-junction solar cells in a CPV array that can store the energy over a longer period of time than conventional batteries and does not exhibit the hazardous conditions of hydrogen storage.

### SUMMARY

According to an embodiment, there is a system, which includes a concentrated photovoltaic (CPV) array that includes a plurality of multi-junction solar cell modules, each of which includes a plurality of multi-junction solar cells and solar concentrating optics mounted on a two-axis solar tracker. The system also includes an energy storage system configured to receive electricity produced by the CPV array and configured to convert the electricity into formic acid by electrolysis.

According to another embodiment, there is a method for operating a concentrated photovoltaic (CPV) array, comprising a plurality of multi-junction solar cell modules, each of which comprises a plurality of multi-junction solar cells mounted on a two-axis solar tracker having a slave solar tracker. A master solar tracker determines coordinates of a current position of the sun. The master solar tracker distributes the determined coordinates to the slave solar trackers. Each of the slave solar trackers determines an actual position of the sun. Each of the slave solar trackers determines whether there is an error in the determined coordinates based on the determined actual position of the sun. Each multi-junction solar cell modules for which the error was determined adjusts the orientation of the plurality of multi junction solar cells with respect to the determined actual position of the sun based on the determined error.

According to a further embodiment, there is a concentrated photovoltaic (CPV) array, which includes a master solar tracker comprising a processor and a communication interface. The CPV array also includes a plurality of multi-junction solar cell modules, each of which comprises a plurality of multi-junction solar cells mounted on a two-axis solar tracker comprising a slave solar tracker, which comprises a processor, communication interface, and a solar feedback sensor. The communication interface of the master solar tracker is communicatively coupled to the communication interface of each of the plurality of multi junction solar cell modules. The processor of the master solar tracker is configured determine coordinates of a current position of the sun, and the wireless communication interface of the master solar tracker is configured to send the determined coordinates to each of the slave solar trackers. The solar feedback sensor of each of the slave solar trackers is configured to capture an image of the sun and the processor of each of the slave solar trackers is configured to determine a tracking error based on at least on a position of the sun in the captured image.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a block diagram of a system according to embodiments;

FIG. 2 is a block diagram of the optics for a multi-junction solar cell according to embodiment;

FIG. 3 is a block diagram of a plate having a number of Fresnel lenses according to embodiments;

FIG. 4 is a diagram of a two-axis solar tracker according to embodiments;

FIG. 5 is a block diagram of a system for converting electricity from a CPV array into formic acid according to embodiments;

FIG. 6 is a block diagram of a master solar tracker and a number of slave solar trackers according to embodiments;

FIG. 7 is a block diagram of the components of a slave solar tracker according to embodiments;

FIG. 8 is a diagram of a solar feedback sensor of a slave solar tracker according to embodiments;

FIG. 9 is a picture of a circuit board containing an imager of a slave solar tracker according to embodiments;

FIG. 10 is a picture of a film for an imager of a slave solar tracker according to embodiments;

FIG. 11 is an image of the sun captured by a slave solar tracker according to embodiments;

FIG. 12 is a block diagram of optics and photo-sensor array for an imager of a slave solar tracker according to embodiments; and

FIG. 13 is a flow diagram of a method for adjusting the orientation of a multi-junction solar cell module according to embodiments.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and multi-junction solar cells and CPV arrays.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

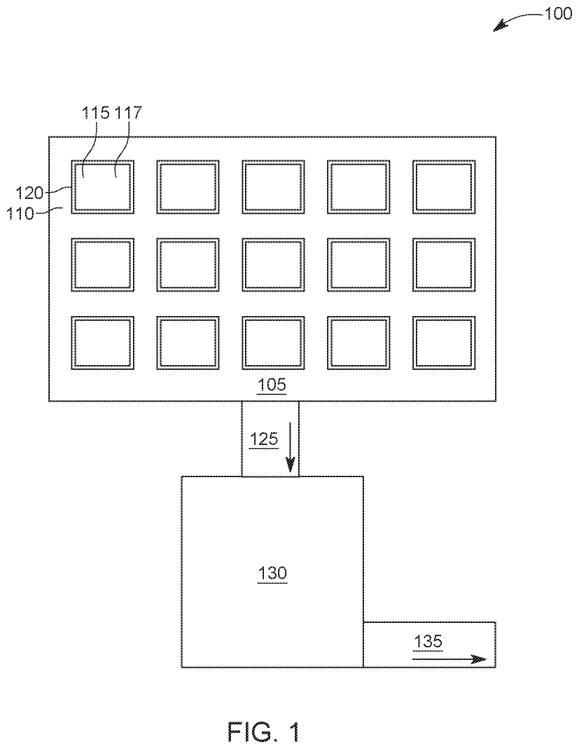

FIG. 1 is a block diagram of a system according to embodiments. The system 100 includes a concentrated photovoltaic (CPV) array 105, which comprises a plurality of multi-junction solar cell modules 110 (only one is labeled in the Figure), each of which comprises a plurality of multi-junction solar cells 115 with solar concentrating optics 117 mounted on a two-axis solar tracker 120. Because the solar concentrating optics 117 are mounted above the plurality of multi-junction solar cells 115, only the solar concentrating optics 117 are visible in this Figure. The system 100 also includes an energy storage system 130 configured to receive electricity produced by the CPV array 105 and configured to convert the electricity into formic acid 135 by electrolysis.

As illustrated in FIG. 1, there is an electrical coupling between the CPV array 105 to provide the electricity to the energy storage system 130. Further, the energy storage system 130 includes an outlet for providing the formic acid 135 to a storage tank.

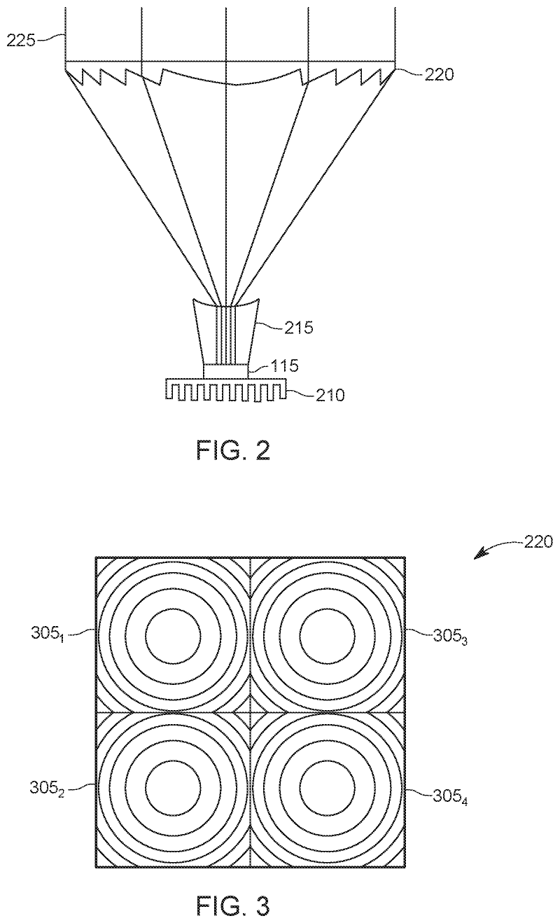

The size of the CPV array 105 can be reduced by using the solar concentrating optics 117, which are illustrated in more detail in FIGS. 2 and 3. Conventionally, a CPV array includes multi-junction solar cells, each with a single Fresnel lens to focus the sun's rays on the multi-junction solar cell, which, due to the focal length of the lens, requires a significant amount of vertical space to focus the sun's rays. This is addressed using a plate of a number of Fresnel lenses in combination with a concave inlet aperture-based homogenizer. Specifically, the plurality of multi-junction solar cells 115 of a multi-junction solar cell module 110 are arranged on a heat sink/spreader 210. A concave inlet aperture-based homogenizer 215 is arranged above the p-n junction 205 and a plate of a number of Fresnel lenses 220 is arranged above the homogenizer 215.

As illustrated in FIG. 3, in one embodiment the plate 220 includes four Fresnel lenses 3051-3054. Accordingly, the sun's rays 225 first pass through the one of the Fresnel lenses of the plate, which focusses the sun's rays 225 on the convex lens 215, which in turn focusses the sun's rays 225 on the plurality of multi-junction solar cells 115. Because a CPV array will typically include a number of sets of the plurality of multi-junction solar cells 115, there will be a heat sink/spreader 210 and homogenizer 215 similarly arranged beneath additional plates of Fresnel lenses for the other sets 1 of the plurality of multi-junction solar cells 115.

The use of the plate with four Fresnel lenses allows for reduction of the overall height of the multi-junction solar cell modules 110 by reducing the focal length of the concentrating lens while still obtaining an equivalent total inlet aperture size compared to the conventional implementation using a single Fresnel lens. Specifically, reducing the size of the lens (here each of the four Fresnel lenses are smaller than the equivalent single Fresnel lens typically employed) the focal distance reduces. Because a single Fresnel lens provides a higher concentration ratio at the individual multi-junction solar cells of the plurality of multi-junction solar cells 115, the concave lens 215 is employed as a homogenizer that also acts as a light guide to guide and concentrates the solar radiation from the Fresnel lens on the individual multi-junction solar cells of the plurality of multi-junction solar cells 115 with minimum optical loss, better beam distribution, and a high acceptance angle.

Conventional multi-junction solar cells employ a single Fresnel lens that is 12 cm×12 cm, whereas using four smaller Fresnel lenses is only, for example, 6 cm×6 cm with a focal length that is 50% smaller than that of the single Fresnel lens, which results in an approximately 40-50% reduction in the overall height of the plurality of multi-junction solar cells 115.

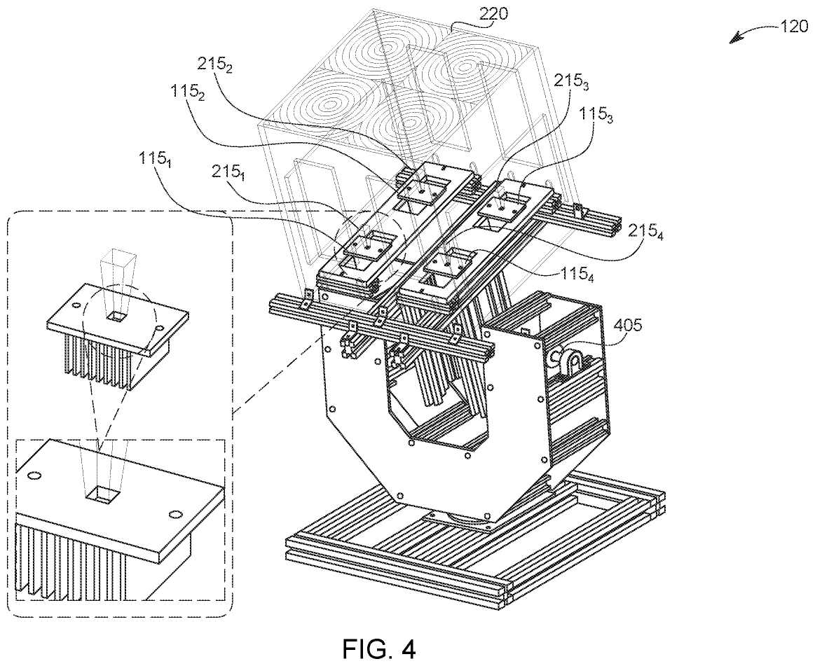

As discussed above, the plurality of multi-junction solar cells 115 are mounted on a two-axis solar tracker. An example of such a tracker is illustrated in FIG. 4. In the illustrated embodiment, the multi-junction solar cell 115 includes four individual multi-junction solar cells 1151-1154, which are mounted on the two-axis solar tracker 120. Each of the multi-junction cells 1151-1154 comprises a plurality of stacked p-n junctions and includes a convex lens 2151-2154 arranged above it and all of the multi-junction cells 115-1154 are covered by the Fresnel lens plate 220. The two-axis solar tracker 120 includes two motors, for adjusting the orientation of the multi-junction solar cell 205 about the two axes (only one of which is visible and it labelled as element 405). Although FIG. 4 illustrates four multi-junction solar cells 205 in a module, the present invention can also employ an arrangement with more than four multi-junction solar cells 205 per module.

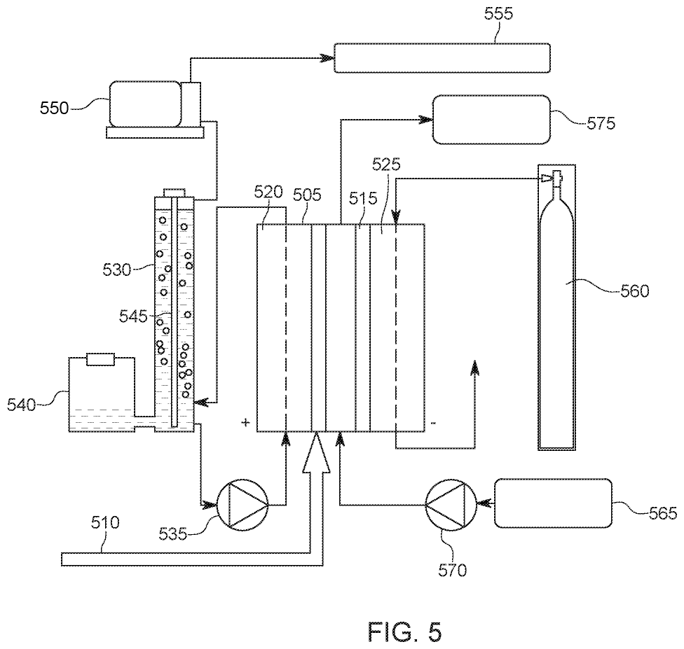

FIG. 5 illustrates the energy storage system 130, which converts electricity received from the CPV array 105 into formic acid 135 by electrolysis. The energy storage system includes a proton exchange membrane (PEM) electrolyzer 505, to which the electricity 510 from the CPV array 105 is applied. The PEM electrolyzer 505 includes PEM 515, which separates the electrolyzer 505 into different chambers 520 and 525. Although FIG. 5 illustrates the energy storage system 130 as including two chambers separated by the PEM 515, the energy storage system can include a plurality of chambers separated by the PEM 515.

The first chamber 520 is fed with water from tank 530 via pump 535. A balancing tank 540 is coupled to a lower portion of tank 530 to balance the water level in tank 530. A level sensor 545 is arranged in tank 530. Oxygen (O₂) released by the water in the tank 530 is sucked out of the tank 530 by a compressor 550, which outputs the oxygen for storage in tank 555. The second chamber 525 is fed with carbon dioxide (CO₂) from tank 560, via pump 570, and depleted carbon dioxide is released from the second chamber 525. Water in tank 565 is feed into the PEM 515. The depleted carbon dioxide will be so diluted so as not to be an environmental concern.

The reaction in the PEM 515 between the water in chamber 505 and the carbon dioxide in chamber 525 produces formic acid, which is output to tank 575. The electrolytic reaction of carbon dioxide and water to form formic acid is summarized in the following equations:

CO₂+H₂O+2e⁻→HCOO⁻+OH⁻ (1)

2H₂O→4H⁺+4e⁻+O₂ (2)

H⁺+OH⁻→H₂O (3)

H⁺+HCOO⁻→HCOOH (4)

The oxygen (O₂) produced by the reaction is fed back into tank 530, from which the excess oxygen can be obtained by compressor 550, which can store the excess oxygen in tank 530. The oxygen produced by this process and stored in tank 555 can then be used in a fuel cell or as a disinfectant (by converting it into ozone). The formic acid produced by this process and stored in tank 560 can then be used as a fuel source for a fuel cell to generate electricity during times when solar rays do not produce sufficient electricity and when there are no solar rays. Alternatively, or additionally, the formic acid can be used to generate electricity at other locations. Storing the energy produced by the CPV solar array 105 as formic acid is particularly advantageous because it does not require high-pressure storage like hydrogen and it is not flammable like hydrogen.

It should be recognized that the particular energy storage system configuration illustrated in FIG. 5 is one example of a system that can convert electricity from a CPV array into formic acid. Other configurations for such a conversion can also be employed.

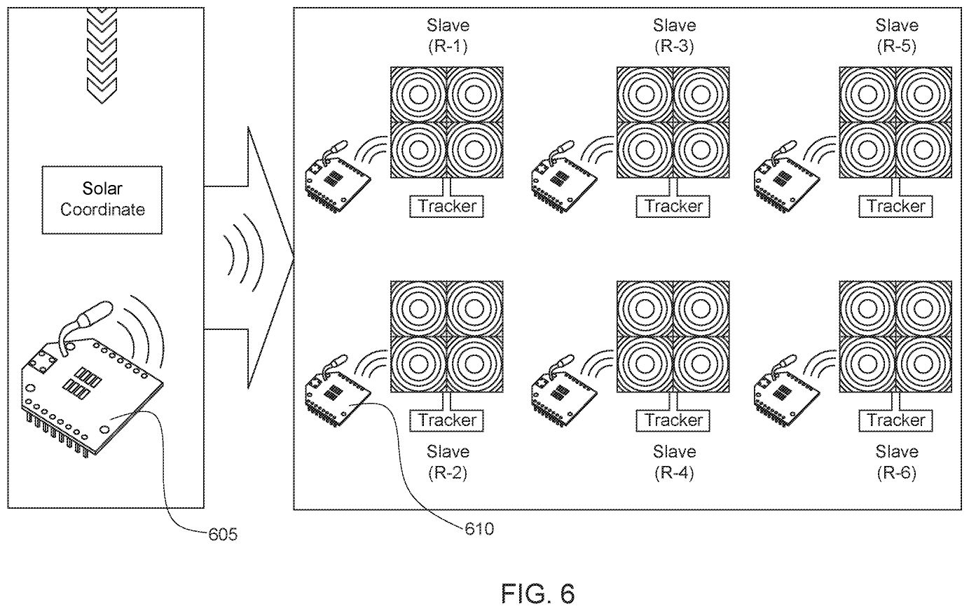

In order to improve the tracking accuracy of the plurality of multi-junction solar cell modules 110 relative to the sun, a distributed orientation determination technique is employed, which uses a master solar tracker that communicates with slave solar trackers of each of the multi-junction solar cell modules 110. Specifically, referring to FIG. 6, the master solar tracker 605 determines the coordinates of the current position of the sun using solar geometry based upon the latitude, longitude, date and time of the location of the master solar tracker 605. The latitude, longitude, date and time of the location can be stored in a memory of the master solar tracker 605. The master solar tracker then distributes the coordinates to each of the slave solar trackers 610 (only one of which is labeled in the Figure), which use the coordinates to perform a final orientation adjustment (if required) using the two-stage solar feedback tracking method that will be described in more detail below.

This master-slave relationship reduces the overall costs of the CPV array because the processing requirements in the slave solar trackers 610 are reduced by having the master solar tracker determine the initial coordinates of the sun. Further, providing the slave solar trackers 610 with coordinates of the sun avoids unnecessary movement of the slave solar trackers 610 during cloudy periods, as well as the tracking errors associated with the astronomical models.

Although the example in FIG. 6 illustrates the coordinates being distributed by wireless communications, a wired communication can be employed instead. Further, the master solar tracker 605 can distribute the coordinates to all of the slave solar trackers 610 or can distribute the coordinates to one or more of the slave solar trackers 610, which can then distribute the coordinates to the remaining slave solar trackers 610.

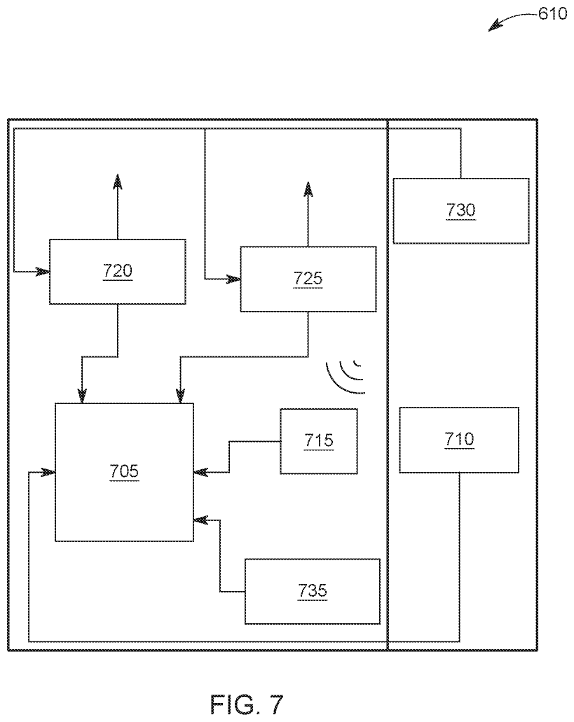

The components of the slave solar tracker 610 are illustrated in FIG. 7. The slave solar tracker 610 includes a processor 705, which can be, for example, an ATmega 2560 microcontroller sold by Microchip Technologies. The processor 705 is coupled an AC/DC converter 710, which can supply, for example, 12 volts AC. The slave solar tracker 610 also includes a wireless communication interface 715, which is coupled to the processor 705 for communication with the master solar tracker 605. The wireless communication interface 715 can employ any type of wireless communication protocol, including, for example, Wi-Fi, Bluetooth, Zigbee, etc. The wireless communication interface 715 can communicate with the processor 705 using, for example, USART.

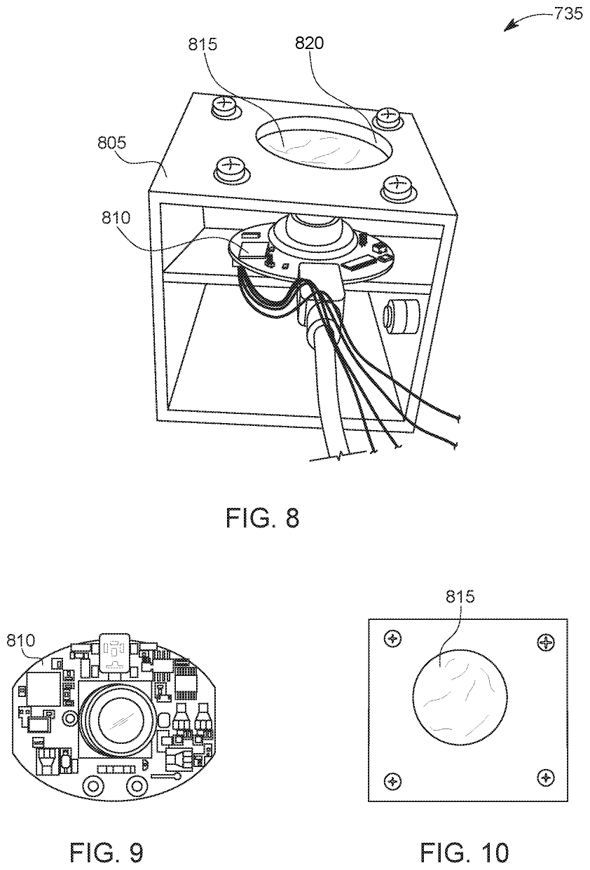

The processor 705 is bidirectionally coupled to a zenith motor driver 720 and azimuth motor driver 725 to control the zenith motor and azimuth motor, respectively (not illustrated). The zenith motor driver 720 and azimuth motor driver 725 are both coupled to a power supply 730, which can be, for example, a 24V DC power supply. Finally, the processor 705 is coupled to solar feedback sensor 735, which provide information about the current position of the sun and which will be described in more detail in connection with FIGS. 8-12. Although the components of the master solar tracker 605 are not separately illustrated, the master solar tracker 605 can be constructed in a manner similar to the slave solar tracker 610, except the master solar tracker 605 would not include zenith motor driver 720, azimuth motor driver 725, power supply 730, and solar feedback sensor 735. Further, the processor in the master solar tracker 605 needs to be one with more processing power than the processor 705 in the slave solar trackers 610 in order to determine and distribute the initial coordinates of the sun.

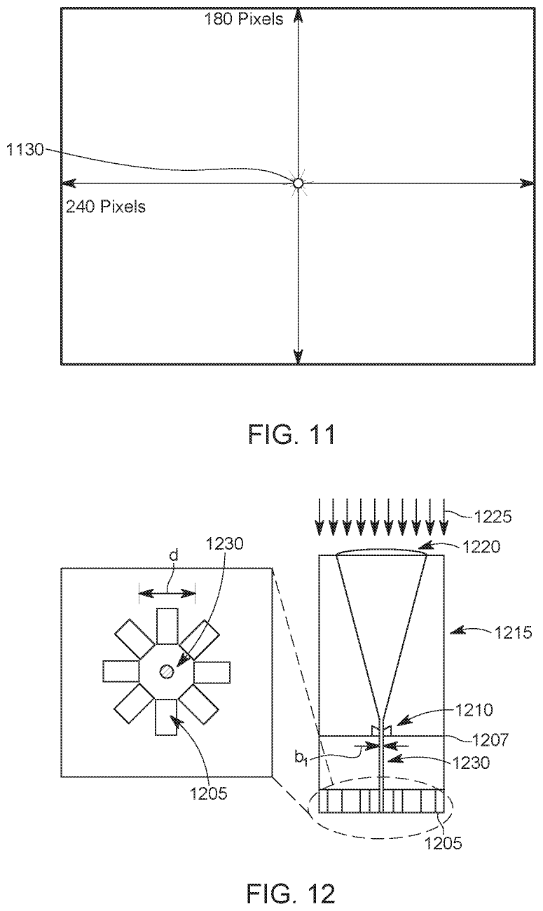

Exemplary embodiments employ a two-stage solar feedback sensor 735, the first stage (discussed in connection with FIGS. 8-11) employs an imager operating in a color tracking sensor mode and the second stage (discussed in connection with FIG. 12) employs a photosensor and optics so that a bright spot from the sun is aligned with a center of the photosensor. The first stage is used for coarse alignment adjustments and the second stage provides fine alignment adjustments starting from the coarse adjustments made during the first stage. This two-stage solar feedback sensor 735 allows the slave solar trackers to achieve very high tracking accuracy, for example 0.1°.

Turning first to FIG. 8, which is a diagram of the first stage of the solar feedback sensor 735 of the slave solar tracker 610 according to embodiments. The first stage of the solar feedback sensor 735 includes a housing 805 enclosing an imager 810, and which has an opening in which a film 815 and optics 820 are arranged to focus the sun's beams on the imager 810. FIG. 9 is a picture of the imager 810, which can be, for example, a CMOS camera.

FIG. 10 is a picture of film 815. The film 815 is designed to filter the incoming sun rays so that only a predetermined amount passes through to the imager 810. Specifically, the actual position of the sun cannot be determined solely by capturing an image of the sky. Accordingly, the film blocks, for example, 98% of the incoming rays so that the imager 810 can be operated in a color tracking mode. Thus, the sun will appear as a small bright spot in the image and the sky will appear as black in the image. Therefore, with the position of bright spot relative to reference point on the imager 810, the position of the sun can be determined. For example, referring now to FIG. 11, alignment of the slave solar tracker 610 relative to the sun's rays can involve adjusting the orientation of the slave solar tracker 610 relative to the sun's rays so that the small bright spot 1130 appears in the center of the imager 810. By tracking the position of the bright spot 1130 relative to a reference point, the position of the sun can be determined over an entire day. Although FIG. 11 illustrates an imager 810 having a resolution of 180 pixels by 240 pixels, the imager 810 can have a different resolution.

FIG. 12 is a block diagram of optics and a photo-sensor array of the slave solar tracker 610 used for the second stage of the solar tracking. The photosensor array 1205 is arranged below a lens holder 1207. A concave lens 1210 is arranged on or above the lens holder 1207. A lens spacer 1215 is arranged between the concave lens 1210 and a convex lens 1220. Accordingly, the concave lens 1210 and the convex lens 1220 acts as a dual lens optical collimator to focus the sun rays 1225 onto the photo-sensor array 1205.

When the slave solar tracker 610 is oriented so that it is aligned with the sun, a collimated sun light spot will impinge upon the center of the photosensor array 1205. In contrast, when there is a tracking error based on the coordinates provided by the master solar tracker 605, the bright spot will not be aligned in the center of the photosensor array and the tracking error can be determined based upon the position of the bright spot against activated sensor in the photosensor array. If the tracking error is greater than the required tracking accuracy, the orientation of the plurality of multi-junction solar cells 115 can be adjusted relative to the sun. The optics 1220 and 1210 provide a concentrated bright spot that can impinge upon the center of the photosensor array with a light intensity larger than its saturation limit. Accordingly, the pixels of the photosensor array 1205 will provide either an extreme high output (if those pixels are impinged upon by the bright spot) or an extreme low output (if those pixels are not impinged upon by the bright spot). Thus, the photosensor array 1205 can be operated in binary mode to avoid non-uniform response under the same light intensity, which allows the use of any conventional photosensor array 1205 and addresses any issues that may arise due to sensing tolerances of different photosensor arrays.

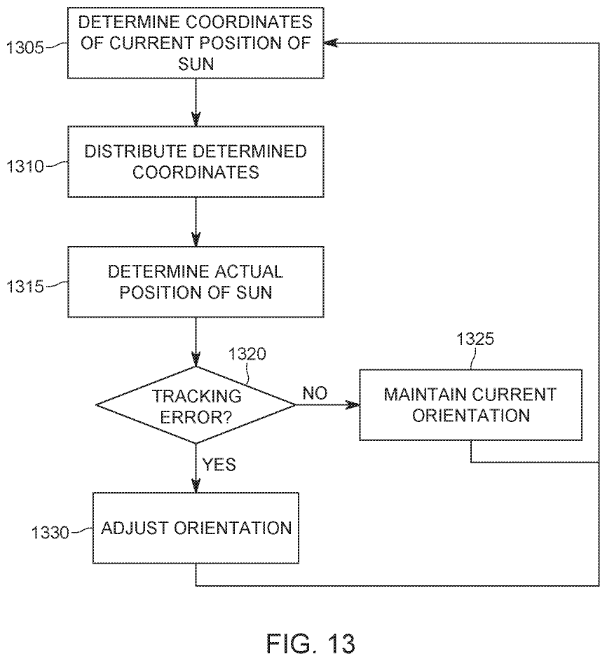

FIG. 13 is a flow diagram of a method for adjusting the orientation of a multi-junction solar cell module according to embodiments. Initially, the master solar tracker 605 determines coordinates of a current position of the sun (step 1305). The master solar tracker 605 then distributes the determined coordinates of the sun to the slave solar trackers 610 (step 1310). This information can be distributed on any schedule, such as every thirty seconds. Each of the slave solar trackers 610 then determines an actual position of the sun (step 1315). This involves the two-stage tracking in which each slave solar tracker 610 initially determines the real-time position of the sun using the first stage of the two-stage solar feedback sensor 735 and then determines whether there is an error in the determined coordinates based on the location of the bright spot on the photosensor array 1205 (step 1320). When a particular one of the slave solar trackers 610 determines that there is no tracking error (“No” path out of decision step 1320), then that slave tracker 610 maintains its current orientation relative to the sun (step 1325) and waits for the master solar tracker 605 to determine and distribute new coordinates of the current position of the sun (step 1305 and 1310). If, however, a particular slave solar tracker 610 determines there is a tracking error (“Yes” path out of decision step 1320), then that particular slave solar tracker 610 adjusts its orientation relative to the sun based on the determined tracking error (step 1330) and waits for the master solar tracker 605 to determine and distribute new coordinates of the current position of the sun (step 1305 and 1310).

The disclosed systems and methods can be employed in a variety of different deployments that are not necessarily achievable with conventional CPV arrays. This is due to the smaller footprint achieved using compact design of Fresnel lenses and a convex lens, as well as safe storage of the electricity produced by the CPV array as formic acid. Specifically, the disclosed systems and methods can operate the CPV array solely to produce formic acid or it can be used to produce formic acid from any excess electricity generated by the CPV array and it not currently being consumed. The formic acid can be used as power when sunlight is not available or can be employed for other uses. For example, the formic acid can be used as a fuel for a fuel cell vehicle. Thus, the disclosed systems and methods can be employed in rooftop installations of residential homes, commercial buildings, as well as in open fields.

Further, due to the distributed master-slave tracking arrangement, the overall cost of the system is reduced because the system does not require high powered processors at each of the slave solar trackers because part of the processing is offloaded to the processor of the master solar tracker. Further, because the disclosed system uses a CPV array with very high tracking accuracy, the disclosed system is two to three times more efficient than conventional single junction arrays.

The disclosed embodiments provide systems for CPV arrays and methods for operating such arrays. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A system, comprising:
a concentrated photovoltaic, CPV, array, comprising a plurality of multi-junction solar cell modules, each of which comprises a plurality of multi-junction solar cells and solar concentrating optics mounted on a two-axis solar tracker; and
an energy storage system configured to receive electricity produced by the CPV array and configured to convert the electricity into formic acid by electrolysis.

2. The system of claim 1, wherein the solar concentrating optics are arranged on top of the plurality of multi-junction solar cells, the solar concentrating optics comprising a plate with a plurality of lenses and a convex lens arranged between each of the plurality of lenses and the plurality of multi-junction solar cells.

3. The system of claim 2, wherein each of the plurality of lenses is a Fresnel lens.

4. The system of claim 1, further comprising:
a master solar tracker comprising a processor and a wireless communication interface,
wherein the two-axis solar tracker of each of the plurality of multi-junction solar cell modules includes a slave solar tracker, each of which comprises a processor and a wireless communication interface.

5. The system of claim 4, wherein the processor of the master solar tracker is configured to determine coordinates of a current position of the sun, and the wireless communication interface is configured to send the determined coordinates to each of the slave solar trackers.

6. The system of claim 5, wherein each of the slave solar trackers further comprises:
an imager configured to capture an image of the sun, wherein the processor of each of the slave solar trackers is configured to determine a tracking error based on a position of the sun in the captured image.

7. The system of claim 6, wherein the processor of each of the plurality of slave solar trackers is configured to adjust an orientation of the corresponding multi-junction solar cell module based on the determined tracking error.

8. The system of claim 6, further comprising:
a film arranged above the imager, wherein the film blocks a portion of incoming rays from the sun to produce a bright spot in the captured image corresponding to the sun.

9. The system of claim 8, wherein the system includes a two-stage solar feedback sensor, a first stage of which comprises the imager and a second stage of which comprises:
an array of photosensors; and
a dual lens optical collimator arranged to focus a bright spot on the array of photosensors.

10. The system of claim 1, wherein the energy storage system comprises:
a proton exchange membrane, PEM, electrolyzer, which comprises of a plurality of chambers separated by PEM,
wherein one of the plurality of chambers is coupled to receive water from a water source, a second one of the plurality of chambers is coupled to a receive carbon dioxide from a carbon dioxide source, and an outlet is coupled in the PEM electrolyzer in an area adjacent to the PEM to output the formic acid.

11. A method for operating a concentrated photovoltaic, CPV, array, comprising a plurality of multi-junction solar cell modules, each of which comprises a plurality of multi-junction solar cells mounted on a two-axis solar tracker having a slave solar tracker, the method comprising:
determining, by a master solar tracker, coordinates of a current position of the sun;
distributing, by the master solar tracker to the slave solar trackers, the determined coordinates;
determining, by each of the slave solar trackers, an actual position of the sun;
determining, by each of the slave solar trackers, whether there is an error in the determined coordinates based on the determined actual position of the sun; and
adjusting, by each multi-junction solar cell module for which the error was determined, an orientation of the plurality of multi-junction solar cells with respect to the determined actual position of the sun based on the determined error.

12. The method of claim 11, wherein the coordinates of the current position of the sun are determined based on a latitude, longitude, date, and time of a location of the master solar tracker.

13. The method of claim 11, wherein the determination of the actual position of the sun by each of the slave solar trackers comprises:
initially adjusting the orientation of the plurality of multi-junction solar cells based on the determined coordinates;
capturing, by an imager, an image;
identifying a location of the sun in the captured image; and
identifying a location of the sun on a photosensor array.

14. The method of claim 13, wherein the capturing of the image comprises:
filtering incoming sun rays to produce filtered rays.

15. The method of claim 13, wherein the adjustment of the orientation of each of the plurality of multi-junction solar cell modules is based on a position of the sun in the captured image and a position of the sun on the photosensor array.

16. A concentrated photovoltaic, CPV, array, comprising:
a master solar tracker comprising a processor and a communication interface; and
a plurality of multi-junction solar cell modules, each of which comprises a plurality of multi-junction solar cells mounted on a two-axis solar tracker comprising a slave solar tracker, which comprises a processor, communication interface, and a solar feedback sensor,
wherein the communication interface of the master solar tracker is communicatively coupled to the communication interface of each of the plurality of multi-junction solar cell modules,
wherein the processor of the master solar tracker is configured determine coordinates of a current position of the sun, and the wireless communication interface of the master solar tracker is configured to send the determined coordinates to each of the slave solar trackers,
wherein the solar feedback sensor of each of the slave solar trackers is configured to capture an image of the sun and the processor of each of the slave solar trackers is configured to determine a tracking error based on at least on a position of the sun in the captured image.

17. The concentrated CPV array of claim 16, wherein each of the plurality of multi-junction solar cell modules comprises:
at least two motors configured to adjust an orientation of the multi-junction solar cell module relative to the sun based on the determined tracking error.

18. The concentrated CPV array of claim 16, wherein each solar feedback sensor is a two-stage solar feedback sensor, comprising:
an imager as part of a first stage of the two-stage solar feedback sensor, wherein the imager captures the image of the sun; and
a second stage, comprising
an array of photosensors; and
a dual lens optical collimator to focus rays onto the array of photosensors.

19. The concentrated CPV array of claim 16, wherein each of the multi-junction solar cells modules comprise:
a plate comprising a plurality of lenses and arranged to focus the sun's rays onto the plurality of multi-junction solar cells.

20. The concentrated CPV array of claim 19, wherein each of the plurality of lenses are Fresnel lenses.
